(19) United States
(12) Patent Application Publication
(10) Pub. No.: US 2026/0193060 A1
(43) Pub. Date: Jul. 9, 2026

(54) LOCK HOOK ASSEMBLY, DOOR HANGING PLATE ASSEMBLY, HALL DOOR LOCK DEVICE, AND ELEVATOR SYSTEM

(71) Applicant: Otls Elevator Company, Farmington, CT (US)

(72) Inventors: Yong Zhao, Shanghai (CN); Jingri Nan, Shanghai (CN); Min Wang, Shanghai (CN)

(21) Appl. No.: 19/395,320

(22) Filed: Nov. 20, 2025

(30) Foreign Application Priority Data
Jan. 9, 2025 (CN) 202510037763.1

(51) Int. Cl. B66B 13/20

(52) U.S. Cl. CPC B66B 13/20

(57) ABSTRACT

A lock hook assembly, a door hanging plate assembly, a hall door lock device, and an elevator system. A lock hook assembly is used for a door hanging plate assembly of a hall door lock device of an elevator system, the lock hook assembly includes a lock hook capable of moving along with the movement of a first hall door of the elevator system and a latch fixedly arranged or capable of moving along with the movement of a second hall door of the elevator system, the lock hook is configured with a hook portion and a rolling body disposed on the hook portion, and the latch includes a main body portion and an inclined portion inclined relative to the main body portion, the main body portion has an accommodating space formed therein.

### FOREIGN PRIORITY

This application claims priority to China Patent Application No. 202510037763.1, filed Jan. 9, 2025, and all the benefits accruing therefrom under 35 U.S.C. § 119, the contents of which in its entirety are herein incorporated by reference.

### TECHNICAL FIELD OF INVENTION

The present disclosure relates to the field of elevator door locks, and in particular to a lock hook assembly, a door hanging plate assembly, a hall door lock device, and an elevator system.

### BACKGROUND OF THE INVENTION

This section is intended to provide background information relevant to understanding various technologies described herein. As the title of this section implies, this is a discussion of relevant technologies which should not in any way be implied as necessarily the prior art. Therefore, it should be understood that any statements in this section should be read in this light, and not as any acknowledgement of the prior art.

It can be learnt from the hall door closing requirements in the Standard EN 81-20:2020 Clause 5.3.9.3.4 that, in the case of hall door driven by the car door, if the hall door becomes open for whatever reason when the car is outside the unlocking zone, a device (either weight or spring) shall ensure closing and locking of the hall door. The main sources of friction during the whole closing operation include: 1) the hanger roller on the track; 2) the slider movement between the hall door and the sill; and 3) frictions between the interlock hook and latch.

### SUMMARY OF THE INVENTION

The purpose of the present disclosure is to solve or at least alleviate the problems existing in the prior art.

According to one aspect, there is provided a lock hook assembly for a door hanging plate assembly of a hall door lock device of an elevator system, wherein the lock hook assembly comprises a lock hook capable of moving along with the movement of a first hall door of the elevator system and a latch fixedly arranged or capable of moving along with the movement of a second hall door of the elevator system, wherein the lock hook is configured with a hook portion and a rolling body disposed on the hook portion, and the latch comprises a main body portion and an inclined portion inclined relative to the main body portion, wherein the main body portion has an accommodating space formed therein, and during the closing process of the first hall door and the second hall door, the rolling body can engage in rolling friction with the inclined portion, and in the closed state of the first hall door and the second hall door, the hook portion is engaged with the accommodating space.

Optionally, according to one embodiment of the present disclosure, the lock hook is configured as a rotatable lock hook; during the closing process of the first hall door and the second hall door, the inclined portion engages in rolling friction with the rolling body, causing the lock hook to rotate, and causing the hook portion to engage with the accommodating space via one side of the main body portion.

Optionally, according to one embodiment of the present disclosure, from the perspective of the direction of closing movement of the lock hook, the hook portion is disposed at the front end of the lock hook, and the rolling body is disposed on a side face of the hook portion, and extends at least partially beyond the end face of the hook portion.

Optionally, according to one embodiment of the present disclosure, the accommodating space is configured to be open toward one side of the main body portion.

Optionally, according to one embodiment of the present disclosure, the lock hook is provided with an operating device for disengaging the lock hook from the latch.

Optionally, according to one embodiment of the present disclosure, the rolling body is a roller, a rolling pin, or a first rolling bearing.

According to another aspect, there is provided a door hanging plate assembly for a hall door lock device of an elevator system, wherein the door hanging plate assembly comprises a first door hanging plate and a second door hanging plate, wherein the first door hanging plate is used for fixed connection with the first hall door, and the second door hanging plate is used for fixed connection with the second hall door; the door hanging plate assembly further comprises any one of the aforementioned lock hook assembly, wherein the lock hook is connected to the first door hanging plate, and the latch is connected to a guide rail assembly of the hall door lock device or the second door hanging plate.

Optionally, according to one embodiment of the present disclosure, the lock hook is provided with a through-hole, wherein a second rolling bearing is arranged inside the through-hole, and the lock hook is rotatably connected to the first door hanging plate via the second rolling bearing.

Optionally, according to one embodiment of the present disclosure, the latch comprises a support portion bent and extending relative to the main body portion, wherein the support portion is fixedly connected with the guide rail assembly or the second door hanging plate.

According to a further aspect, there is provided a hall door lock device for an elevator system, wherein the hall door lock device comprises any one of the aforementioned door hanging plate assembly, a spring and a guide rail assembly, wherein the first door hanging plate and the second door hanging plate can be rollably connected with the guide rail assembly, one end of the spring is fixed to the guide rail assembly and the other end is connected to the second door hanging plate, and the spring is configured to provide a spring force to the closing of the first hall door and the second hall door.

According to yet another aspect, there is provided an elevator system, wherein the elevator system comprises the aforementioned hall door lock device.

The lock hook assembly according to the embodiments of the present disclosure can reduce friction during the engagement between the lock hook and the latch in a cost-effective manner, thereby meeting the closing operation requirements specified by the Standard.

### BRIEF DESCRIPTION OF THE DRAWINGS

The content of the present disclosure will become easier to understand with reference to the drawings. It can be readily appreciated by a person skilled in the art that these drawings are for illustrative purposes only, and are not intended to limit the scope of protection of the present disclosure. In addition, similar numerals in the drawings denote similar components, wherein:

FIG. 1 is a schematic diagram of an exemplary elevator system;

FIG. 2 is a partial plan view of an exemplary elevator system in the area of a hall door lock device;

FIG. 3 is a partial plan view of an exemplary hall door lock device in the area of a lock hook assembly;

FIG. 4 is a schematic diagram of the engagement relationship of an exemplary lock hook assembly;

FIG. 5 is a schematic diagram of the engagement relationship of an exemplary lock hook assembly during the closing process;

FIG. 6 is a structural diagram of an exemplary lock hook;

FIG. 7 is a structural diagram of an exemplary latch; and

FIG. 8 is a partial plan view of an exemplary hall door lock device in the area of another lock hook assembly.

### DETAILED DESCRIPTION OF THE INVENTION

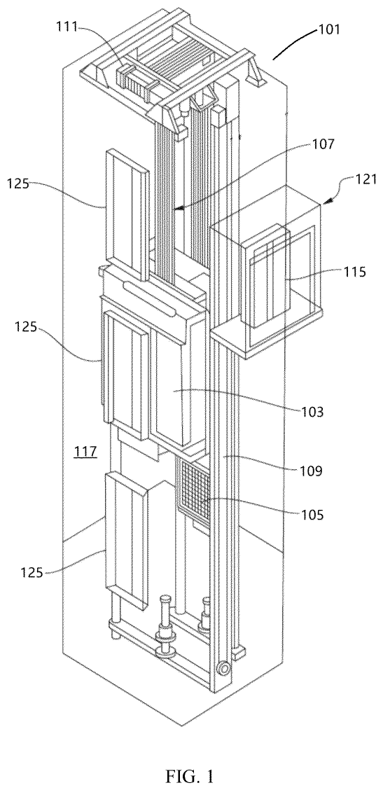

FIG. 1 is a perspective view of an elevator system 101 that includes an elevator car 103, a counterweight 105, ropes 107, guide rails 109, a traction machine 111 and an elevator system controller 115. The elevator car 103 and the counterweight 105 are connected to each other via ropes 107. The ropes 107 may include or be configured as, for example, cords, steel cables and/or a coated steel belt, and in this embodiment, the ropes are configured as a rope belt integrating a plurality of ropes. The counterweight 105 is configured to balance the load of the elevator car 103 and to facilitate synchronized, counter-directional movement of the elevator car 103 relative to the counterweight 105 within an elevator hoistway 117 and along the guide rails 109. The ropes 107 engage with the traction machine 111 which is part of an overhead structure of the elevator system 101. The traction machine 111 is configured to control movement between the elevator car 103 and the counterweight 105.

The elevator system controller 115 as illustrated is positioned within an elevator system controller room 121 of the elevator hoistway 117, and is configured to control operation of the elevator system 101 and in particular the elevator car 103. For example, the elevator system controller 115 may provide a drive signal to the traction machine 111 to control the acceleration, deceleration, leveling, stopping, etc. of the elevator car 103. When moving up or down along the guide rails 109 in the elevator hoistway 117, the elevator car 103 as controlled by the elevator system controller 115 can stop at one or more landings 125. Although the elevator system controller 115 is shown within the elevator system controller room 121, a person skilled in the art will appreciate that the elevator system controller 115 may be located and/or configured at other position or location within the elevator system 101. The traction machine 111 may include a motor or a similar drive mechanism.

Although a rope system has been presented and described, elevator systems that utilize other methods and mechanisms for moving an elevator car within an elevator hoistway may also implement the embodiments of the present disclosure. FIG. 1 is a non-limiting example presented for illustrative and explanatory purposes only.

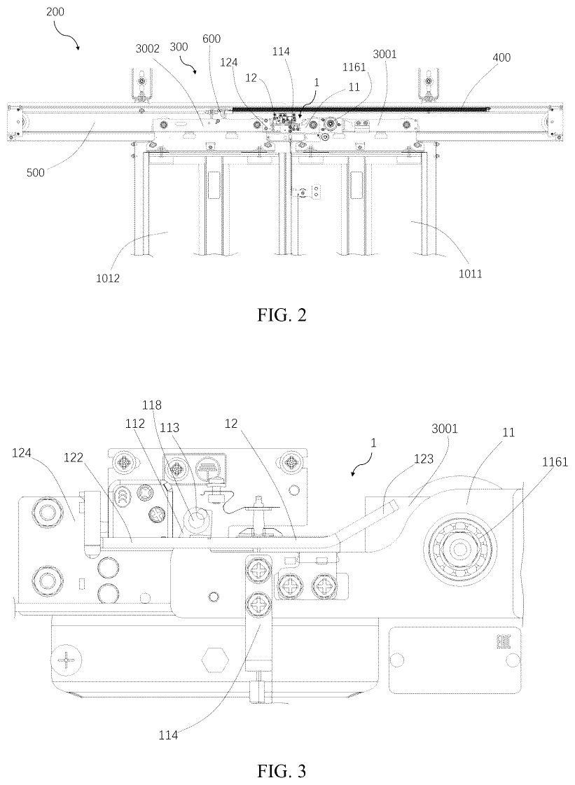

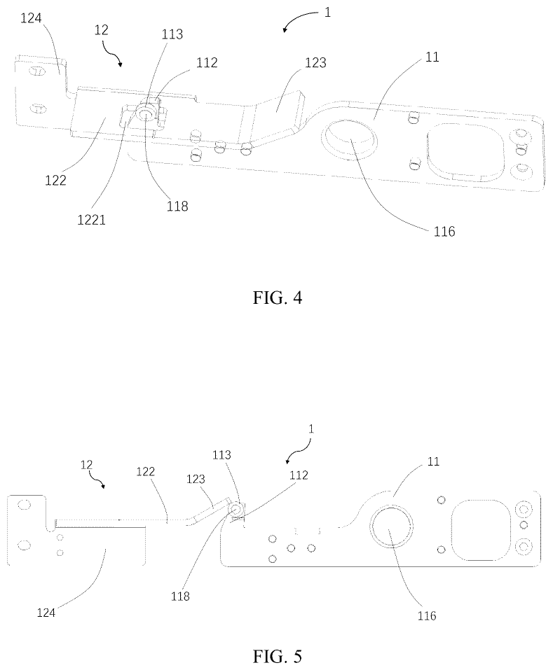

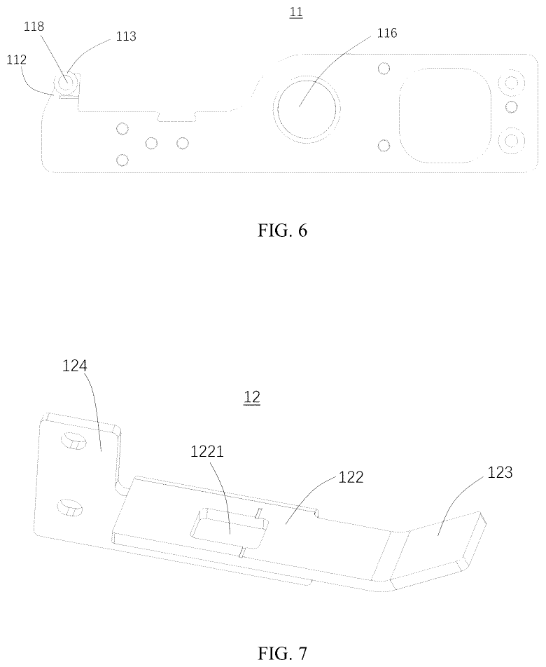

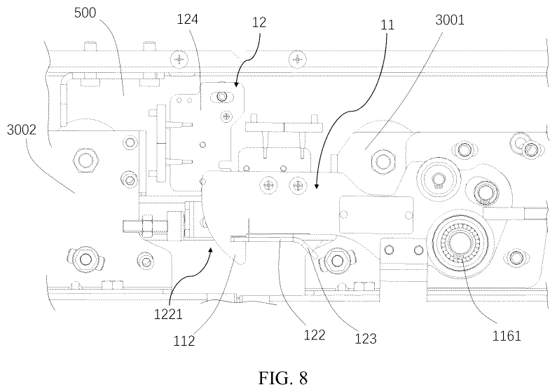

FIG. 2 is a partial plan view of an exemplary elevator system in the area of a hall door lock device; FIG. 3 is a partial plan view of an exemplary hall door lock device in the area of a lock hook assembly; FIG. 4 is a schematic diagram of the engagement relationship of an exemplary lock hook assembly; FIG. 5 is a schematic diagram of the engagement relationship of an exemplary lock hook assembly during the closing process; FIG. 6 is a structural diagram of an exemplary lock hook; FIG. 7 is a structural diagram of an exemplary latch; and FIG. 8 is a partial plan view of an exemplary hall door lock device in the area of another lock hook assembly.

The present disclosure relates to a lock hook assembly 1 for a door hanging plate assembly 300 of a hall door lock device 200 of an elevator system 101, wherein the lock hook assembly 1 comprises a lock hook 11 capable of moving along with the movement of a first hall door 1011 of the elevator system 101 and a latch 12 fixedly arranged or capable of moving along with the movement of a second hall door 1012 of the elevator system 101, wherein the lock hook 11 is configured with a hook portion 112 and a rolling body 113 disposed on the hook portion 112, and the latch 12 comprises a main body portion 122 and an inclined portion 123 inclined relative to the main body portion 122, wherein the main body portion 122 has an accommodating space 1221 formed therein, and during the closing process of the first hall door 1011 and the second hall door 1012, the rolling body 113 can engage in rolling friction with the inclined portion 123, and in the closed state of the first hall door 1011 and the second hall door 1012, the hook portion 112 is engaged with the accommodating space 1221.

The present disclosure recognizes that the measurement of motor current can be used to evaluate whether the self-closing force of a landing door or hall door is still greater than the resistance force of a lock hook assembly. If the resistance force is too great, for example, debris exists on the inclined surface of the lock hook assembly, closing failure may occur at that location due to excessive friction/blockage. The threshold setting for the resistance force of the lock hook assembly is very difficult due to a large range of variation in sliding friction coefficient, which is related to the cleanliness of the inclined surface. It will also have a side effect on the callback rate of the hall door that cannot be closed by a self-closer (either weight or springs).

Therefore, in the present technical solution, a rolling body is specially designed, to reduce friction through rolling friction engagement between the rolling body and the inclined surface, so that self-closing force can overcome the friction of the lock hook assembly where necessary (for example, when the car is outside the unlocking zone, and the hall door becomes open for whatever reason) to smoothly close the first hall door and the second hall door, and at the same time enable the lock hook and the latch to achieve locking engagement. As such, the aforementioned side effect on the callback rate can be reduced, particularly in situations where the friction coefficient increases due to the accumulation of impurities (ashes and the like) from the long-term use of the lock hook assembly, e.g., inclined portion and other parts, the rolling friction method can well cope with this situation, making the closing process of the hall doors smoother, and reducing the noise and abrasion caused by friction. Compared with other methods of overcoming the friction, such as adding a weight or increasing a counterweight, the rolling friction method is more economical. Finally, since the rolling friction engagement in the present technical solution has a relatively small range of fluctuation in frictional resistance, this can expand the coverage of the Internet of Things (IOT) solution and enable more accurate predictions.

It can also be appreciated that, in some embodiments, the lock hook and the latch can establish either a direct or indirect fixed connection with the corresponding hall door respectively, so as to move along with the movement of the hall door. Consequently, when the hall door is closed, locking is achieved conveniently, with the hook portion of the lock hook passing through the accommodating space of the main body portion of the latch. During the closing process, the rolling body will first engage in rolling friction with the inclined portion of the latch. In this regard, a person skilled in the art should know that the friction factor or the rolling frictional resistance can be adjusted by designing the material, the size (diameter, width), the inclination, the surface roughness and the like of the inclined portion or the rolling body, to set a reasonable resistance threshold. This can expand the coverage of the IOT solution and enable more accurate predictions. In addition, this can also avoid damage caused by too fast movement of the hall door when it is necessary to smoothly close the hall door.

In some other embodiments, the latch is fixedly arranged, for example, fixedly disposed on a fixed guide rail assembly. As such, the latch is fixed to the guide rail assembly, and does not move along with the door hanging plate or hall door. The lock hook, through its movement with the corresponding hall door, engages with the fixed latch to realize door lock closure.

As for the guide rail assembly, it can be understood that the guide rail assembly may be an integrated structure, which on the one hand provides guidance for the door hanging plate that is rollably connected to the guide rail assembly, and on the other hand is fixedly arranged and provides fixed connection for the latch. The guide rail assembly may also constitute a split structure, which one the one hand has a guide rail portion for the rolling of the door hanging plate, and on the other hand has a fixed portion for securing the latch. The fixed portion may also be referred to as an upper sill back plate of the hall door lock device.

In addition, the accommodating space should be understood in a broad sense, and generally refers to interspace that can be hooked by the hook portion of a lock hook for engagement. The accommodating space is, for example, an opening or open space.

The arrangement of the rolling body can also effectively disperse the stress generated in the locking process, and prevent damage to components caused by stress concentration. Meanwhile, the abrasion loss of the rolling friction is relatively small, which can extend the service life of the lock hook assembly and the entire hall door lock device. It is also feasible that the lock hook assembly has better adaptability to small gaps or unevenness between the hall doors due to the rolling friction engagement between the rolling body and the inclined portion. Even if the hall door is slightly deformed or worn in long-term use, the lock hook assembly can still maintain good locking effect. In addition, the locking engagement between the lock hook and the latch not only achieves the locking function, but also enhances locking stability through the close fit between the hook portion and the accommodating space. This ensures that the hall door does not accidentally open due to vibrations or external forces during the elevator operation.

It is also feasible that the rolling body is installed on the hook portion by riveting through a rotating shaft 118, which can provide relatively strong connection strength and stability, ensure secure connection of the rolling body on the hook portion, and prevent potential safety hazards caused by loose connection or disconnection. The design of the rotating shaft reduces the frictional resistance between the rolling body and the hook portion, enhances the structural stability, and improves the rotation flexibility. This helps to achieve more smooth and efficient locking or opening actions and also simplifies the installation process and improves the durability. In addition, the riveting can simplify the installation process, reduce the difficulty and costs of installation, and have relatively good durability and fatigue resistance. In occasions where it is necessary to frequently open or close the hall door lock device or the like, this design can ensure that the connection between the rolling body and the hook portion maintains stability and reliability in long-term use, and extend the service life of the device.

In some embodiments of the present disclosure, the lock hook 11 is configured as a rotatable lock hook. During the closing process of the first hall door 1011 and the second hall door 1012, the inclined portion 123 engages in rolling friction with the rolling body 113, causing the lock hook 11 to rotate, and causing the hook portion 112 to engage with the accommodating space 1221 via one side (e.g., the lower side) of the main body portion 122.

Therefore, the inclined portion has dual functions. It not only can achieve the effect of rolling friction with the rolling body and the effect of threshold setting, but also can serve to guide the movement, so that the rolling body and the lock hook can rotate downward in the inclination direction of the inclined portion (taking the perspective of FIG. 3 as an example), and further move transversely along the length direction of the main body portion and extend into the accommodating space when encountering it. Such rotary movement can guide the hook portion to extend more smoothly into the accommodating space of the main body portion, thereby achieving quick locking, improving the locking efficiency, and reducing the time required for closing the hall doors. As the lock hook is rotatable, it can better adapt to slight deviation or unevenness in the closing process of the hall doors. Even if there are tiny gaps or unevenness between the hall doors, the lock hook can also adjust the position of the hook portion through rotation to ensure that the hook portion can accurately extend into the accommodating space, which enhances the locking reliability and reduces the risk of locking failure caused by unevenness or deviation of the hall doors.

For this purpose, the lock hook can be configured with a certain retention tight locking force, so that the lock hook maintains a tendency of tight locking when it rotates via the inclined portion, and thus extends into the accommodating space through rotation when the hook portion encounters the accommodating space and maintains tight locking. A person skilled in the art can know how to design the orientation of the inclined portion to guide the movement as needed. In this embodiment, the inclined portion is inclined upward, and its mating surface with the rolling body is the lower side face. The lock hook rotates counterclockwise, and vice versa. It can also be understood that the number of components required for the design of the rotatable lock hook is relatively small, which not only reduces the manufacturing cost, but also makes the maintenance and replacement of the lock hook assembly more convenient and faster. In the daily maintenance and overhaul process of the elevator system, it is much easier to check and replace the lock hook assembly, and ensure safe operation of the elevator system.

From the perspective of the closing movement direction of the lock hook, the hook portion 112 is disposed at the front end (left end) of the lock hook 11, and the rolling body 113 is disposed on a side face (front face) of the hook portion 112 and extends at least partially beyond the end face (left face) of the hook portion 112.

Therefore, it can be ensured that the rolling body preferentially engages in rolling friction with the inclined surface of the inclined portion, thereby achieving the expected effect, reducing the jamming or deviation in the closing process, and improving the locking precision and efficiency. Moreover, disposing the rolling body on a side face can also ensure compactness of the lock hook in the length direction, while not affecting the effect of rolling friction engagement. The rolling body partially extending beyond the end face of the hook portion can also provide more flexibility and convenience when installing and adjusting the lock hook assembly. The installation or maintenance personnel can conveniently adjust the position and angle of the rolling body according to the actual condition, to ensure optimal engagement between the lock hook and the latch.

In some other embodiments, the accommodating space 1221 is configured to open toward one side (front side or back side) of the main body portion 122. As such, under the circumstance that the hook portion can maintain engagement with the accommodating space, the accommodating space can better accommodate the rolling body. Even if the size of the rolling body is designed to be relatively large (e.g., for reasons related to the design of a frictional resistance threshold), the open design can enhance the capacity of the accommodating space, i.e., the rolling body can be partially located inside the accommodating space, and partially extended outside the accommodating space via an open portion.

This also provides the hook portion of the lock hook with a larger space to extend into, so that the hook portion can extend into the accommodating space more easily and smoothly during the closing process of the hall doors, thereby improving the locking efficiency and precision. The open design of the accommodation space allows the hook portion to have some leeway in adjustment after extending into the accommodating space. Even if there is slight deviation or unevenness during the closing process of the hall doors, the hook portion can still make adjustment in the accommodating space to ensure formation of a stable locking structure with the main body portion, thereby enhancing the locking stability, and also better adapting to lock hooks of different sizes and shapes. During the design and manufacturing process of the elevator system, there is a certain fault-tolerant or adaptive range for the specific size and shape of the lock hook and the latch, which reduces the difficulty in manufacturing and installation. During the maintenance process, it is also easier to check and clean the accommodating space and the hook portion, and extend the service life of the assembly.

The lock hook 11 is provided with an operating device 114, which is used to disengage the lock hook 11 from the latch 12. This allows for visualized and convenient opening of the hall doors by unlocking the locking engagement where necessary. For example, in case of an emergency or when maintenance of the elevator system is required, the operating device can quickly and conveniently disengage the lock hook from the latch, thereby opening the hall doors. This enhances the emergency response capability of the elevator system, and ensures the safety of passengers and staff. The operating device can be used manually or automatically. The operating device is exemplarily fixed to the front face of the lock hook, or may have other layout, for example, disposed on the end face (left face) etc. In this embodiment, when the operating device is activated, the lock hook rotates counterclockwise to disengage the hook portion from the accommodating space, thereby opening the hall doors.

The rolling body 113 is a roller, a rolling pin, or a first rolling bearing. Among them, the roller has notable features in rolling smoothness, bearing capacity, and maintenance; the rolling pin has advantages in rolling precision, adaptability and service life; and the rolling bearing is characterized with stable support, flexible rotation, high bearing capability and rotation precision etc. A person skilled in the art can select the appropriate type of the rolling body according to specific use requirements and conditions, to ensure normal operation of the hall door lock device and safety performance of the elevator system.

The present disclosure also relates to a door hanging plate assembly 300 for a hall door lock device 200 of an elevator system 101, wherein the door hanging plate assembly 300 comprises a first door hanging plate 3001 and a second door hanging plate 3002, wherein the first door hanging plate 3001 is used for fixed connection with the first hall door 1011, and the second door hanging plate 3002 is used for fixed connection with the second hall door 1012; the door hanging plate assembly 300 further comprises any one of the aforementioned lock hook assembly 1, wherein the lock hook 11 is connected to the first door hanging plate 3001, and the latch 12 is connected to a guide rail assembly 500 of the hall door lock device 200 or the second door hanging plate 3002.

Therefore, the door hanging plate assembly of the present disclosure can incorporate various implementations and corresponding technical effects of the lock hook assembly. According to this technical solution, the corresponding hall door drives the door hanging plate to move, the door hanging plate drives the corresponding latch or lock hook to open or close, or the door hanging plate drives the lock hook to move, while the latch is fixedly arranged. The installation process is made simpler and more convenient by using the door hanging plate or guide rail assembly configured according to this technical solution as an intermediate element, which enhances the structural stability of the entire hall door lock device. Even if vibration or shock is generated during the elevator operation, the engagement between the lock hook assembly and the latch assembly remains stable, ensuring safe closing of the hall door. When the hall door is closed, the lock hook assembly can quickly and accurately engage with the latch assembly, achieving efficient locking while also ensuring reliability and durability of the locking process.

The lock hook 11 is provided with a through-hole 116, wherein a second rolling bearing 1161 is arranged inside the through-hole 116, and the lock hook 11 is rotatably connected to the first door hanging plate 3001 via the second rolling bearing 1161.

This technical solution describes the implementation method of a rotatable lock hook. By using a rolling bearing, the frictional resistance during the movement process can be significantly reduced, enabling the lock hook to rotate more smoothly and reducing energy loss and abrasion. The rolling bearing also has the characteristics of high precision and high rigidity, which can ensure stability and accuracy of the lock hook during rotation, enable precise engagement between the lock hook and the latch, and enhance reliability and safety of the hall door lock device. The maintenance and replacement of the rolling bearing is also relatively simple, which reduces maintenance costs. In addition, the rolling bearing can withstand a relatively heavy load and impact, making it suitable for various complex working environments. Therefore, the lock hook can deal with various emergencies, such as emergency braking and accidental impact, ensuring safe locking of the hall door.

The latch 12 comprises a support portion 124 bent and extended relative to the main body portion 122, wherein the support portion 124 is fixedly connected with the guide rail assembly 500 or the second door hanging plate 3002. The bent and extended design of the supporting portion provides an additional supporting area for the latch, and enhances the overall structural strength of the latch, so that the latch can better resist deformation and damage when it is subjected to an external force, ensuring stable engagement between the latch and the lock hook. This also ensures secure connection between the latch and the guide rail assembly or the second door hanging plate, reduces potential safety hazards caused by loose connection or disconnection, and improves connection reliability of the hall door lock device.

Furthermore, such bent design provides convenience for installation and adjustment. A person skilled in the art can determine the arrangement position and the bending form of the support portion according to the inner space of the door lock device and the relative positions of the door hanging plate and the lock hook, so that the lock hook and the latch can be well closed or unlocked.

The present disclosure also relates to a hall door lock device 200 for an elevator system 101, wherein the hall door lock device 200 comprises any one of the aforementioned door hanging plate assembly 300, a spring 400 and a guide rail assembly 500, wherein the first door hanging plate 3001 and the second door hanging plate 3002 can be rollably connected with the guide rail assembly 500, one end of the spring 400 is fixed to the guide rail assembly 500 and the other end is connected to the second door hanging plate 3002, and the spring 400 is configured to provide a spring force to the closing of the first hall door 1011 and the second hall door 1012.

Likewise, the hall door lock device of the present disclosure can incorporate the implementations and technical benefits of various door hanging plate assemblies. This technical solution further specifies the spring and the guide rail assembly, wherein the guide rail assembly is used to guide and limit the movement of the door hanging plate, so that the movement of the hall door and the lock hook assembly can also be regulated. Exemplarily, the door hanging plate and the guide rail assembly may be connected by rollers. The rolling connection method reduces friction and vibration of the door hanging plate during movement, making the opening or closing movement of the hall door more smooth and steady.

The spring provides a self-closing force, and a person skilled in the art can adjust the spring stiffness coefficient according to specific requirements by adjusting the material, quantity, series or parallel connection, size, and form (straight or tapered spring) of the spring, to better overcome the rolling frictional resistance and realize the hall door closure. In this connection, the spring can be directly or indirectly connected to the second door hanging plate. In this embodiment, this is achieved by an adapter bracket 600 with a hook, which on one hand is fixed to the second door hanging plate, and on the other hand is connected an end of the spring by the hook. When the hall door is open, the spring is stretched, increasing the self-closing force, thereby providing sufficient spring force to overcome the rolling frictional resistance. In addition, when the hall door is closed, the spring continues to provide a self-closing force, ensuring stable closure of the hall doors, enhancing sealing and safety of the hall doors, and preventing potential safety hazards due to loose closure.

The present disclosure further relates to an elevator system 101, wherein the elevator system 101 comprises the aforementioned hall door lock device 200, and can incorporate its various implementations and technical effects, which will not be repeated here.

The specific embodiments of the present disclosure as described above are only for the purpose of describing the principles of the present disclosure more clearly, wherein various components are clearly shown or described to make the principles of the present disclosure easier to understand. A person skilled in the art can easily make various modifications or changes to the present disclosure without departing from the scope of the present disclosure. Therefore, it should be understood that these modifications or changes should fall within the patent protection scope of the present disclosure.

What is claimed is:

1. A lock hook assembly (1) for a door hanging plate assembly (300) of a hall door lock device (200) of an elevator system (101), wherein the lock hook assembly (1) comprises a lock hook (11) configured to move along with the movement of a first hall door (1011) of the elevator system (101) and a latch (12) fixedly arranged or configured to move along with the movement of a second hall door (1012) of the elevator system (101), wherein the lock hook (11) is configured with a hook portion (112) and a rolling body (113) disposed on the hook portion (112), and the latch (12) comprises a main body portion (122) and an inclined portion (123) inclined relative to the main body portion (122), wherein the main body portion (122) has an accommodating space (1221) formed therein, and during the closing process of the first hall door (1011) and the second hall door (1012), the rolling body (113) in configured to engage in rolling friction with the inclined portion (123), and in the closed state of the first hall door (1011) and the second hall door (1012), the hook portion (112) is configured to engage with the accommodating space (1221).

2. The lock hook assembly (1) according to claim 1, wherein the lock hook (11) is configured as a rotatable lock hook; during the closing process of the first hall door (1011) and the second hall door (1012), the inclined portion (123) engages in rolling friction with the rolling body (113), causing the lock hook (11) to rotate, and causing the hook portion (112) to engage with the accommodating space (1221) via one side of the main body portion (122).

3. The lock hook assembly (1) according to claim 1, wherein from the perspective of the direction of closing movement of the lock hook, the hook portion (112) is disposed at the front end of the lock hook (11), and the rolling body (113) is disposed on a side face of the hook portion (112), and extends at least partially beyond the end face of the hook portion (112).

4. The lock hook assembly (1) according to claim 1, wherein the accommodating space (1221) is configured to be open toward one side of the main body portion (122).

5. The lock hook assembly (1) according to claim 1, wherein the lock hook (11) is provided with an operating device (114) for disengaging the lock hook (11) from the latch (12).

6. The lock hook assembly (1) according to claim 1, wherein the rolling body (113) is a roller, a rolling pin, or a first rolling bearing.

7. A door hanging plate assembly (300) for a hall door lock device (200) of an elevator system (101), wherein the door hanging plate assembly (300) comprises a first door hanging plate (3001) and a second door hanging plate (3002), wherein the first door hanging plate (3001) is used for fixed connection with the first hall door (1011), and the second door hanging plate (3002) is used for fixed connection with the second hall door (1012); the door hanging plate assembly (300) further comprises the lock hook assembly (1) according to claim 1, wherein the lock hook (11) is connected to the first door hanging plate (3001), and the latch (12) is connected to a guide rail assembly (500) of the hall door lock device (200) or the second door hanging plate (3002).

8. The door hanging plate assembly (300) according to claim 7, wherein the lock hook (11) is provided with a through-hole (116), wherein a second rolling bearing (1161) is arranged inside the through-hole (116), and the lock hook (11) is rotatably connected to the first door hanging plate (3001) via the second rolling bearing (1161).

9. The door hanging plate assembly (300) according to claim 7, wherein the latch (12) comprises a support portion (124) bent and extended relative to the main body portion (122), wherein the support portion (124) is fixedly connected with the guide rail assembly (500) or the second door hanging plate (3002).

10. A hall door lock device (200) for an elevator system (101), wherein the hall door lock device (200) comprises the door hanging plate assembly (300) according to claim 7, a spring (400) and a guide rail assembly (500), wherein the first door hanging plate (3001) and the second door hanging plate (3002) can be rollably connected with the guide rail assembly (500), one end of the spring (400) is fixed to the guide rail assembly (500) and the other end is connected to the second door hanging plate (3002), and the spring (400) is configured to provide a spring force to the closing of the first hall door (1011) and the second hall door (1012).

11. An elevator system (101), wherein the elevator system (101) comprises the hall door lock device (200) according to claim 10.
